(19) United States
(12) Patent Application Publication
(10) Pub. No.: US 2014/0249456 A1
(43) Pub. Date: Sep. 4, 2014

(54) TAMPON ASSEMBLY

(71) Applicant: MARLAFIN AG, Hagendorn (CH)

(72) Inventors: Axel Hammen, Lengnau (CH); Joachim Lange, Uhlingen-Birkendorf (DE)

(21) Appl. No.: 14/349,882

(22) PCT Filed: Oct. 15, 2012
(86) PCT No.: PCT/EP2012/070426

§ 371 Date: Apr. 4, 2014

(30) Foreign Application Priority Data
Oct. 26, 2011 (EP) 11186696.8

(51) Int. Cl. A61H 23/00

(52) U.S. Cl. CPC A61H 23/00
USPC 601/46

(57) ABSTRACT

The tampon assembly has a load, e.g. a vibration element, accommodated in a tampon and connected to a first end of a cable assembly (4). To a second end of the cable assembly (4) is connected a housing (5) containing at least one electric component. The second end of the cable assembly (4) is connected to the housing (5) mechanically and to the at least one electric component electrically by releasable coupling means (7). To prevent this connection from being separated by a tensile force acting upon the cable assembly (4), e.g. when retracting the tampon from the body, the coupling means (7) and the housing (5) are provided with locking means (10, 12).

The invention relates to a tampon assembly having a load arranged in a tampon and connected to a first end of a cable assembly and a housing connected to a second end of the cable assembly and containing at least one electric component.

The reference EP1231885B1 relates to a vibrating tampon apparatus for relieving menstrual pain. The apparatus comprises a vibration element arranged in a tampon and an energy supply unit that is connected to the tampon by a cable assembly and in which an electric component in the form of an energy source is arranged. As a further electric component, an operating element in the form of a push button is arranged in the housing that controls the electric connection between the electric energy source and the vibration element. In the intended use, the vibration element is permanently connected to the energy source and this connection cannot be interrupted so that the vibration element vibrates until the energy source is exhausted. After use, the entire apparatus including the energy source has to be disposed of, which is not only ecologically unfavorable but also entails relatively high costs for the user. Although the battery can be removed and separately disposed of in the device that has become known under the publication number EP2360755A1, this assembly also suffers from the disadvantage that the housing with the other components arranged therein is discarded together with the used tampon.

In the present context, the term “load” is meant to denote any element that consumes electric energy. This includes not only the mentioned vibration element but e.g. also heating and measuring elements, particularly for therapeutic or diagnostic purposes. In the present context, the term “electric component” is meant to denote operating elements such as switches or push buttons, control elements such as integrated circuits, and energy sources such as batteries or rechargeable batteries, in particular.

On the background of this prior art, the invention is based upon the object of further developing a tampon assembly of the kind mentioned in the introduction in such a manner that parts thereof can be reused.

According to the invention, this object is attained in that the second end of the cable assembly is connected to the housing mechanically and to the at least one electric component electrically by releasable coupling means, and in that the coupling means and the housing comprise locking means that prevent a separation of the coupling means by a tensile force acting between the cable assembly and the housing.

In particular, this solution offers the advantage that not only a releasable electrical and mechanical connection is ensured by the coupling means but also an involuntary disconnection by a tensile force acting between the cable assembly and the housing is prevented by the locking means. The latter characteristic is very important in such tampon assemblies since it should be possible to retract the tampon from the body of a user by means of the housing.

Particular embodiments of the invention are described in the dependent claims.

Exemplary embodiments of the invention will be explained in more detail hereinafter by way of examples with reference to the accompanying drawings showing

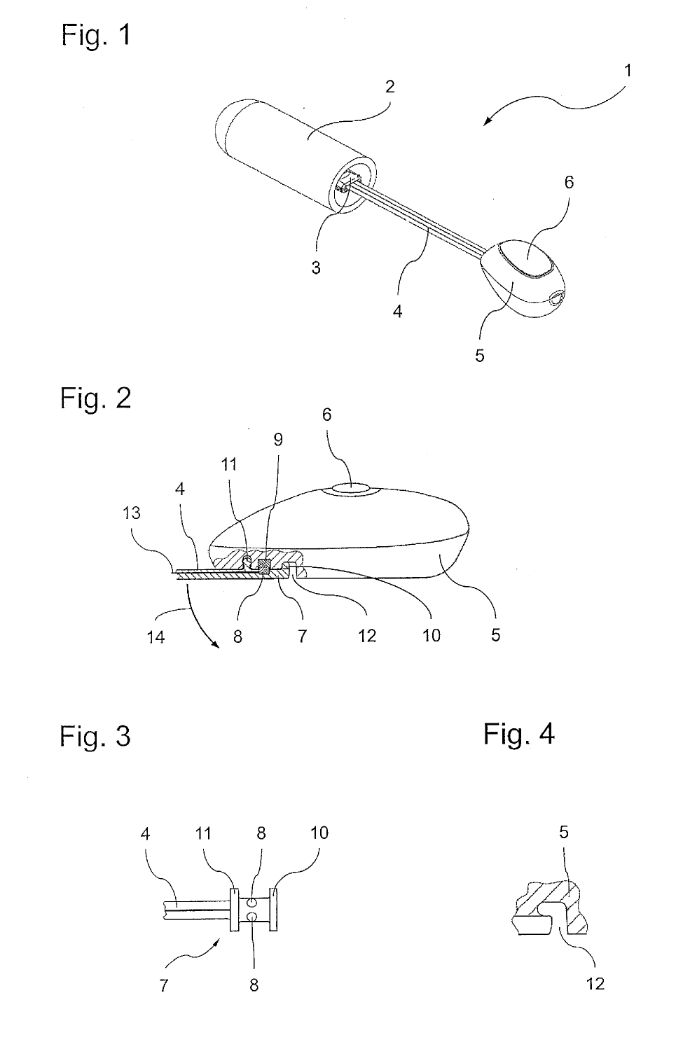

FIG. 1 a perspective view of a tampon assembly known from the prior art,

FIG. 2 a lateral view of a first embodiment of the invention,

FIG. 3 a top view of a detail of FIG. 1,

FIG. 4 a detail of FIG. 2 on an enlarged scale,

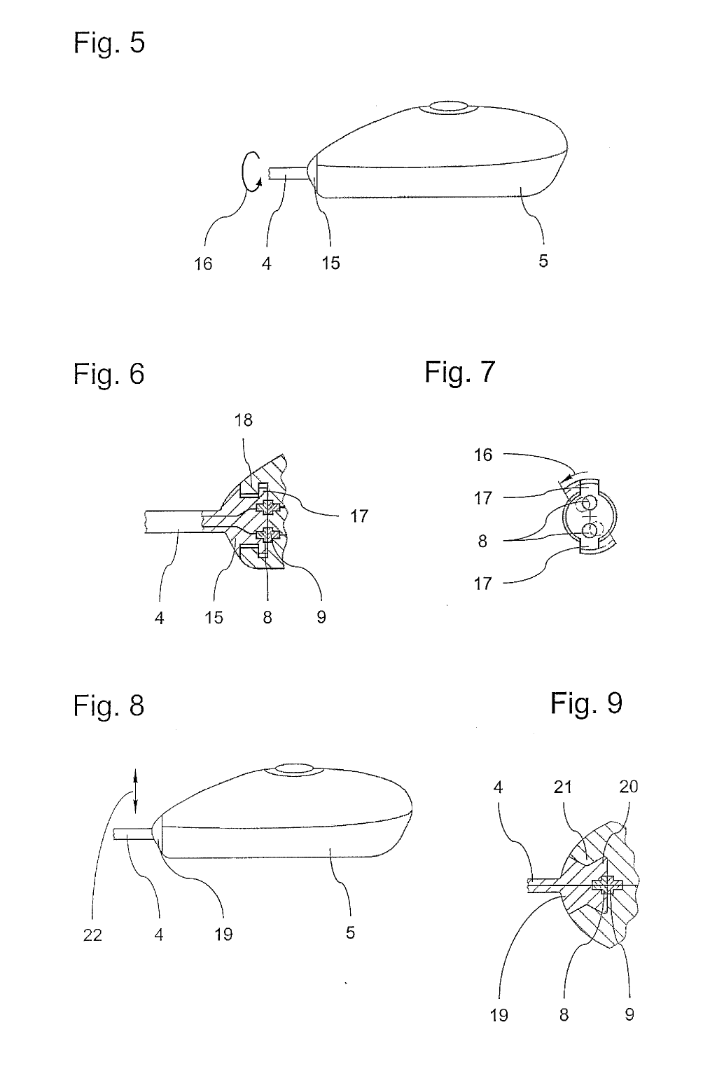

FIG. 5 a lateral view of a second embodiment of the invention,

FIG. 6 a sectional view of a detail of FIG. 5,

FIG. 7 a view of the detail of FIG. 6 rotated 90 degrees,

FIG. 8 a lateral view of a third embodiment of the invention, and

FIG. 9 a partly sectioned top view of a detail of FIG. 8.

FIG. 1 shows a tampon assembly 1 known from the prior art, consisting of a tampon 2, a vibration element 3 accommodated in tampon 2, a cable 4, and a housing 5. Housing 5 contains a first electric component in the form of a battery serving as an energy source and a second electric component in the form of an operating element 6 for actuating vibration element 3. As a further electric component, a control unit may be provided that comprises e.g. at least an integrated circuit. Cable 4 serves for transmitting energy from the battery to vibration element 3 and simultaneously as the withdrawal element for retracting tampon 2 from a body orifice, which is why the assembly has to withstand relatively high tensile forces. This assembly suffers from the disadvantages mentioned in the introduction.

FIGS. 2 to 4 show a first exemplary embodiment of the assembly of the invention where, as in FIG. 1, reference numeral 4 denotes a cable, 5 a housing, and 6 an operating element arranged in housing 5. A coupling part 7 serves for the mechanical connection of cable 4 to housing 5 and for the electric connection of the conductors 13 in cable 4 to at least one electric component incorporated in housing 5, e.g. an electronic circuit for the control of an electric load arranged in tampon 2, e.g. a vibration element. The mechanical connection of coupling part 7 to housing 5 is achieved by means of a stem 10 located in a slot 12 in housing 5. FIG. 4 shows in more detail that slot 12 has an angled configuration. On the left of stem 10 in FIG. 2 a detent element 11 is arranged that engages in a slightly undercut opening provided in the housing. The electric connection is achieved by contacts 8 arranged in coupling part 7 which enter into contact with contacts 9 arranged in housing 5. To release the connection, coupling part 7 is swung away from housing 5 around axis 10 in the direction of arrow 14 whereby detent element 11 is disengaged from the aforementioned opening. Subsequently, coupling part 7 is moved against the longitudinal extension of cable 4 and then stem 10 is removed from slot 12 downwardly in FIG. 2.

In a non-represented variant of this embodiment, slot 12 is not angulate as illustrated but straight and arranged perpendicularly to coupling part 7. In this case, stem 10 or a similar element not only acts as a locking element but also as a guiding element that fits into the mentioned straight slot. This variant of the coupling is connected and disconnected by straight movements perpendicularly to cable 4.

FIGS. 5 to 7 show a second embodiment of the tampon assembly of the invention. In this embodiment, a coupling part 15 is connected to cable 4 and shaped so as to be connected to housing 5 and disconnected therefrom in a bayonet-like manner by a rotation according to arrow 16. On coupling part 15 two wings 17 are arranged which engage behind correspondingly shaped housing portions 18 in the connected state. In this embodiment, contact pairs 8 and 9 are brought together and separated in a mutually sliding manner. In one variant of this embodiment, wings 17 are not arranged symmetrically as illustrated but offset so as to form an angle of e.g. 120 degrees between them. In this manner it is ensured that coupling part 15 is always attached in the correct position by the user and the polarity is not reversed. Furthermore, detent means may be provided, e.g. in the form of a projection arranged on coupling part 15 that engages in a corresponding recess arranged in housing 5 and thus secures the coupling part in the connected position.

FIGS. 8 to 9 show a third embodiment of the tampon assembly of the invention. Here, a coupling part 19 arranged on cable 4 is dovetail-shaped so as to engage with its enlarged coupling portion 20 behind a constricted housing portion 21 when coupling part 19 is connected to housing 5 in the direction of arrow 22. In this embodiment also, contact pairs 8 and 9 are brought together and separated in a mutually sliding manner. Moreover, in this embodiment, stop means may be provided which prevent that coupling part 19 is pushed beyond its intended position during the connection. Furthermore, detent means may also be provided as previously described with regard to the second embodiment.

Operating element 6 need not necessarily be arranged in housing 5 but may alternatively be integrated in cable 4 between tampon 2 and housing 5 or fastened to an additional cable that projects from housing 5.

### List of Reference Numerals

1 Tampon Assembly
2 Tampon
3 Vibration Element
4 Cable
5 Housing
6 Operating Element
7 Coupling Part
8 Contacts in 7
9 Contacts in 5
10 Stem
11 Detent Element
12 Slot
13 Conductor
14 Arrow
15 Coupling Part
16 Arrow
17 Wing
18 Housing Portion
19 Coupling Part
20 Coupling Portion
21 Housing Portion
22 Arrow
23
24
25

1. Tampon assembly comprising a load arranged in a tampon and connected to a first end of a cable assembly and a housing connected to a second end of the cable assembly and containing at least one electric component, wherein the second end of the cable assembly is connected to the housing mechanically and to the at least one electric component electrically by releasable coupling means, and in that the coupling means and the housing comprise locking means that prevent a separation of the coupling means by a tensile force acting between the cable assembly and the housing.

2. Tampon assembly according to claim 1, wherein the coupling means include a body having locking means and electric contacts.

3. Tampon assembly according to claim 2, wherein the locking means include a stem arranged on the body and extending substantially perpendicularly to the cable assembly and a slot arranged in the housing for receiving the stem.

4. Tampon assembly according to claim 3, wherein the slot has an open end, an adjoining section extending substantially perpendicularly to the cable assembly, an adjoining section extending substantially parallel to the cable assembly and toward the latter, and an adjoining closed end.

5. Tampon assembly according to claim 2, wherein the coupling means include a body having wings projecting from the body in a plane perpendicular to the cable assembly which engage behind portions provided on the housing in a bayonet-like manner.

6. Tampon assembly according to claim 2, wherein the coupling means include a body having an enlargement arranged on its side facing away from the cable assembly which engages behind portions arranged in the housing in a dovetail-like manner.

7. Tampon assembly according to claim 1, further comprising detent means which secure the coupling means in their connected position.

8. Tampon assembly according to claim 1, wherein an electric component arranged in the housing is an electronic circuit for controlling the load.

9. Tampon assembly according to claim 1, wherein an electric component arranged in the housing is an energy source.

10. Tampon assembly according to claim 1, wherein an electric component arranged in the housing is an operating element.

11. Tampon assembly according to claim 1, wherein the cable assembly has an operating element arranged therein.

12. Tampon assembly according to claim 1, wherein at the free end of another cable assembly connected to the housing an operating element is arranged.
